(19) United States
(12) Patent Application Publication
(10) Pub. No.: US 2008/0314505 A1
(43) Pub. Date: Dec. 25, 2008

(54) METHOD FOR MANUFACTURING TIRE RUBBER MEMBER

(75) Inventor: Kazuma Nishitani, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/128,773

(22) Filed: May 29, 2008

(30) Foreign Application Priority Data
Jun. 21, 2007 (JP) 2007-163904

(51) Int. Cl. B29D 30/08

(52) U.S. Cl. 156/123

(57) ABSTRACT

A method for manufacturing a tire rubber member, the method comprising: spirally winding a rubber ribbon including a first rubber portion and a second rubber portion, each composed of a rubber having different physical characteristics and joined to each other with a boundary face extending therebetween along a longitudinal direction thereof, along a circumferential direction of a tire so that the second rubber portion is disposed on an outer peripheral side of the first rubber portion, to form the tire rubber member in which a second rubber layer formed with the second rubber portion is built up on the outer periphery of the tire of a first rubber layer formed with the first rubber portion.

### BACKGROUND OF THE INVENTION

1. Field of the Invention

The present invention relates to a method for manufacturing a tire rubber member formed by spirally winding a rubber ribbon along a circumferential direction of a tire.

2. Description of the Related Art

A pneumatic tire is composed of many rubber layers formed and shaped by building up and bonding a plurality of rubber members. Conventionally, as a method for forming a tire rubber member, a ribbon winding method is known. The ribbon winding method is a method for forming a rubber member in which a rubber ribbon of small width and small thickness composed of a rubber composition before curing is wound spirally along a circumferential direction of a tire. Compared to the case where an extruded rubber is cut to obtain a desired sectional shape of a rubber member, it is possible to form a rubber member more easily and accurately by winding a rubber ribbon.

In the ribbon winding method, a lamination structure, which includes a rubber layer 31 and a rubber layer 32 composed of a rubber having physical characteristics different from those of the rubber layer 31 as illustrated in FIG. 8A, is formed in the following manner. That is, a rubber ribbon is spirally wound along a circumferential direction of a tire first to form a rubber member constituting the rubber layer 31 as illustrated in FIG. 8B. Subsequently, a rubber ribbon composed of a rubber having physical characteristics different from those of the rubber layer 31 is wound on the outer peripheral side of the above-mentioned rubber member to form a rubber member constituting the rubber layer 32.

As mentioned above, in the conventional ribbon winding method, different rubber ribbons have to be wound in order to form rubber layers each having different physical characteristics. Therefore, the conventional ribbon winding method has a drawback that each of the rubber layers has to be positioned for bonding, and therefore, a considerably long time is required for forming the rubber member. Also, when a thinner mouthpiece for extruding a rubber ribbon is used, a larger apparatus has to be used to increase the extruding pressure. And also, there is a substantial limit to reduce the thickness of the rubber ribbon. Accordingly, it was difficult to reduce thickness of a rubber layer with the ribbon winding method.

Japanese Unexamined Patent Publication No. 10-193475 discloses a method for forming a tread rubber including a plurality of rubber layers, in which a plurality of kinds of rubber ribbons each having different physical characteristics are separately and simultaneously wound for several times. However, in the above method, since the different kinds of rubbers require the winding of the different kind of rubber ribbons, positioning for bonding is required for each of the rubber layers. Accordingly there is a drawback that a considerably long time is required to form a rubber member.

Japanese Unexamined Patent Publication No. 11-227415 discloses a method for forming a tread rubber by winding a rubber ribbon which is mixed with silica at a high ratio and is provided with a conductive rubber portion on a side or the like in a longitudinal direction thereof. However, this method is for forming a rubber member which includes a rubber layer mixed with silica at a high ratio and including a conductive rubber layer therein in a ladder or net-like configuration. This method is not for forming a lamination structure as mentioned above.

Japanese Unexamined Patent Publication No. 2002-79590 discloses a method for forming a rubber member in which a surface layer is formed first by winding a rubber ribbon with a predetermined small overlapping width, and subsequently another rubber ribbon is wound on the surface layer.

However, in this method also, different rubber ribbons have to be wound separately for several times to form a rubber member. Therefore, a considerably long time is required for forming the rubber member. Furthermore, since there is substantially a limit to reduce the thickness of the rubber ribbon, it is difficult to make the rubber member thinner. In this method, the thickness of the rubber layer depends on the thickness of the rubber ribbon. Therefore, it is difficult to make the rubber member thinner.

### SUMMARY OF THE INVENTION

In view of these circumstances mentioned hereinbefore, the present invention has been made. It is an object of the present invention to provide a method for manufacturing a tire rubber member capable of forming a thin rubber layer, and capable of reducing forming time of a tire rubber member so that productivity of a tire can be increased.

The above-mentioned object can be achieved by the present invention as follows. That is, the present invention provides a method for manufacturing a tire rubber member, the method comprising: spirally winding a rubber ribbon including a first rubber portion and a second rubber portion, each composed of a rubber having different physical characteristics and joined to each other with a boundary face extending therebetween along a longitudinal direction thereof, along a circumferential direction of a tire so that the second rubber portion is disposed on an outer peripheral side of the first rubber portion, to form the tire rubber member in which a second rubber layer formed with the second rubber portion is built up on the outer periphery of the tire of a first rubber layer formed with the first rubber portion.

According to the method for manufacturing a tire rubber member of the present invention, the rubber ribbon which includes the first rubber portion and the second rubber portion each composed of a rubber having different physical characteristics and joined to each other with the boundary face extending therebetween along a longitudinal direction thereof, is spirally wound along a circumferential direction of a tire so that the second rubber portion is disposed on the outer peripheral side of the first rubber portion; thereby double-layered rubber can be formed at a time. Therefore, compared to a conventional method for manufacturing a rubber member in which a plurality of rubber ribbons are wound separately, the forming time of the rubber member can be reduced, and thus the productivity of a tire can be increased.

Further, according to the present invention, there is used the rubber ribbon which includes the first rubber portion and the second rubber portion each composed of a rubber having physical characteristics different from each other and joined to each other with the boundary face extending therebetween along a longitudinal direction thereof. Accordingly, it is possible to form each of the rubber layers having a thickness corresponding to the first and the second rubber portions. Therefore, compared to the conventional method, a thin rubber layer can be effectively formed.

In the method mentioned hereinbefore, it is preferable that the first rubber portion is composed of a low air permeable rubber, and the tire rubber member is formed to include an inner liner layer as the first rubber layer and an intermediate layer as the second rubber layer, said intermediate layer is interposed between the inner liner layer and a carcass layer. According to the method, the first rubber portion is composed of a low air permeable rubber. Thereby the tire rubber member having the inner liner layer and the intermediate layer can be formed at a time while ensuring the function as an inner liner layer. Also, the thickness of each of the inner liner layer and the intermediate layer can be satisfactorily reduced, therefore a reduction of the weight of a tire can be achieved.

In the method mentioned hereinbefore, it is preferable that the second rubber portion is composed of a rubber of which an oil-containing ratio is higher than that of the first rubber portion, and the tire rubber member is formed to constitute a base rubber of a tread including a low oil-containing layer as the first rubber layer and a high oil-containing layer as the second rubber layer. According to the method, by constituting the inner periphery side of the base rubber of the low oil-containing layer and by constituting the outer peripheral side of the base rubber of the high oil-containing layer, the belt-separation resistance can be increased on the inner periphery side of the base rubber near the belt layer, as well as the groove cracking resistance can be increased on the outer peripheral side of the base rubber near the groove portion. Also, according to the present invention, it is possible to form relatively thin base rubber having the above lamination structure.

### BRIEF DESCRIPTION OF THE DRAWINGS

FIG. 1 is a cross sectional view of an example of a rubber ribbon used in the present invention;

FIG. 2 is a schematic view of an arrangement of an apparatus for winding a rubber ribbon;

FIG. 3 is a cross sectional view of an example of a tire rubber member having an inner liner layer and an intermediate layer;

FIG. 4 is a cross sectional view of an example of a tire rubber member constituting a base rubber of a tread having a low oil-containing layer and a high oil-containing layer;

FIG. 5 is a cross sectional view of another example of a rubber ribbon used in the present invention;

FIG. 6 is a cross sectional view of still another example of a rubber ribbon used in the present invention;

FIG. 7 is a cross sectional view of another example of a tire rubber member having an inner liner layer and an intermediate layer; and

FIG. 8 is a view illustrating a conventional ribbon winding method for forming a lamination structure.

### DETAILED DESCRIPTION OF THE PREFERRED EMBODIMENTS

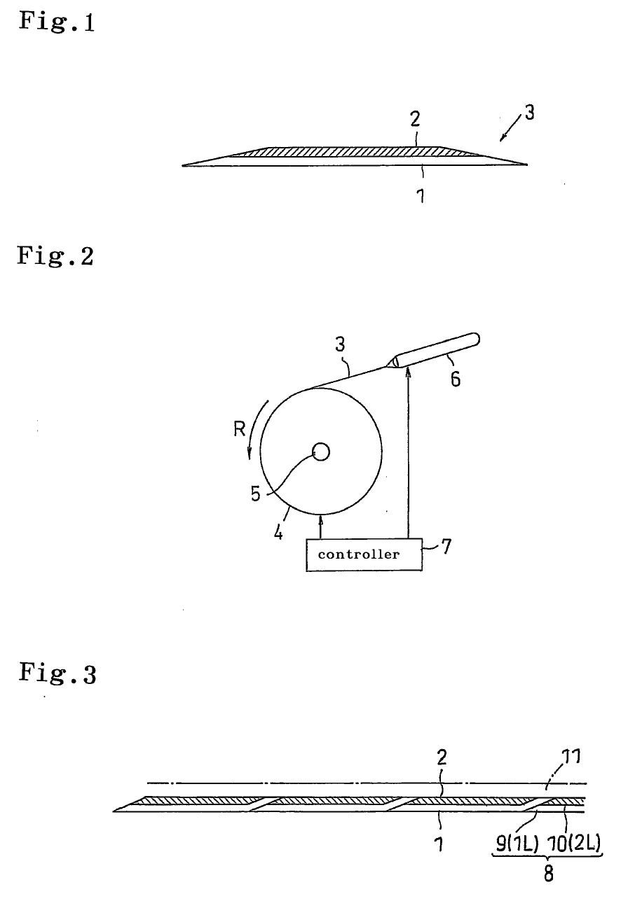

An embodiment of the present invention will be described below with reference to the drawings. The present invention is characterized by using a rubber ribbon 3 which includes a first rubber portion 1 and a second rubber portion 2 as illustrated in FIG. 1 as an example. Each of the rubber portions is composed of rubber having physical characteristics different from each other. The rubber portions are joined to each other with a boundary face extending along a longitudinal direction thereof. The rubber ribbon 3 has a trapezoidal shape in cross section. The rubber ribbon 3 is composed of the first rubber portion 1 and the second rubber portion 2 which are overlapped with each other in a thickness direction with the boundary face extending in a width direction thereof. The rubber ribbon 3 may be formed by, for example, multilayer extrusion.

In a method for manufacturing a tire rubber member according to the present invention, for example, an apparatus illustrated in FIG. 2 may be used to form the tire rubber member. A shaping drum 4 is adapted to rotate in an “R” direction about a drum shaft 5. A rubber ribbon supplier 6 has a function to supply the rubber ribbon 3. The rubber ribbon supplier 6 is adapted to move in a drum shaft direction by means of a moving mechanism (not shown). The controller 7 controls the rotation of the shaping drum 4 and the movement of the rubber ribbon supplier 6.

In the above-mentioned apparatus, first of all, a winding start end of the rubber ribbon 3 is fixed to the outer peripheral surface of the shaping drum 4. Then, the rubber ribbon supplier 6 is moved in the drum shaft direction while rotating the shaping drum 4 in the “R” direction. The controller 7 appropriately coordinates the rotation speed of the shaping drum 4 and the movement speed of the rubber ribbon supplier 6 in the drum shaft direction. With this arrangement, the rubber ribbon 3 is wound spirally along a circumferential direction of a tire and a rubber member having predetermined dimensions and a sectional shape is formed.

FIG. 3 illustrates an example of a tire rubber member 8 manufactured according to the embodiment. The rubber member 8 has an inner liner layer 9 and an intermediate layer 10 disposed between the inner liner layer 9 and a carcass layer 11.

The rubber ribbon 3 is wound spirally along a circumferential direction of a tire so that the second rubber portion 2 is disposed on the outer peripheral side of the first rubber portion 1, thereby it is possible to simultaneously form a first rubber layer 1L and a second rubber layer 2L which are build up one another. Also, the first rubber layer 1L and the second rubber layer 2L can be formed to have thicknesses corresponding respectively to the first rubber portion 1 and the second rubber portion 2.

In the tire rubber member 8 formed by the above-described method, the first rubber portion 1 is constituted of a low air permeable rubber. The tire rubber member 8 has the inner liner layer 9 as the first rubber layer 1L and the intermediate layer 10 as the second rubber layer 2L disposed between the inner liner layer 9 and the carcass layer 11. According to this method, the tire rubber member 8 which includes the inner liner layer 9 and the intermediate layer 10 can be formed at a time while ensuring the function as the inner liner layer 9.

As the rubber ribbon 3 used for forming the tire rubber member 8 including the inner liner layer 9 and the intermediate layer 10, there is exemplified a rubber ribbon of a width more than 20 mm and less than 95 mm and a thickness more than 0.5 mm and less than 2.0 mm. The ratio of the thickness of the rubber ribbon 1 with respect to the thickness of the first rubber portion 3 is, for example, more than 0.2 and less than 0.8. In the rubber ribbon 3, the ratio of the width of the second rubber portion 2 with respect to the width of the first rubber portion 1 is, for example, more than 0.5 and less than 2.0. The overlapping width when the rubber ribbon 3 is wound spirally along a circumferential direction of a tire is, for example, more than 5% and less than 60% with respect to the width of the rubber ribbon 3.

The low air permeable rubber constituting the first rubber portion is a kind of rubber that has substantially air-impermeable characteristic represented by butyl rubber. For example, butyl rubber, butyl rubber halide, copolymer rubber of isobutyl rubber with paramethylstyrene, nitrile rubber and the like are exemplified as the low air permeable rubber. Such low air permeable rubber may be used by itself or in combination with two or more kinds. Further, the low air permeable rubber may be used in combination with natural rubber, isoprene rubber, butadiene rubber or the like to the extent that low air permeability of the inner liner layer is not affected.

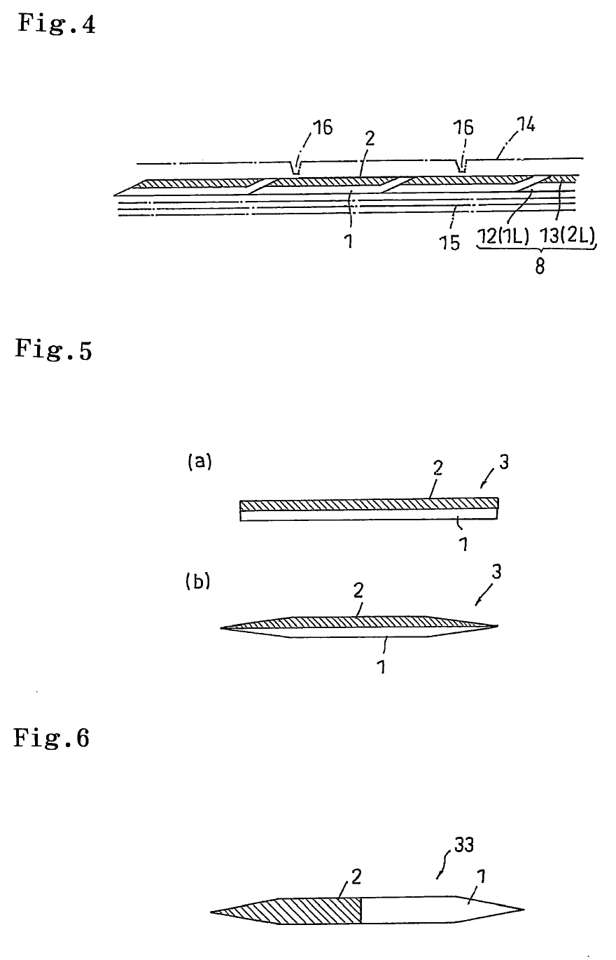

FIG. 4 illustrates an example of a tire rubber member 8 manufactured according to another embodiment of the present invention. The tire rubber member 8 is constituted of a first rubber portion 1 and a second rubber portion 2. The second rubber portion 2 is made of rubber that contains oil at a ratio higher than that of the first rubber portion 1. The tire rubber member 8 constitutes a base rubber of a tread including a low oil-containing layer 12 as a first rubber layer 1L and a high oil-containing layer 13 as a second rubber layer 2L.

In the present embodiment, disposed on the outer peripheral side of the tire rubber member 8 constituting the base rubber of the tread is a cap rubber 14 having a plurality of groove portions 16 constituting a tread pattern, and disposed on the inner periphery side is a belt layer 15. In the tire rubber member 8 formed as described above, the inner peripheral layer of the base rubber is constituted of the low oil-containing layer 12, and the outer peripheral layer is constituted of the high oil-containing layer 13.

Generally, a tire tends to generate thin and tiny cracks in the bottom of the groove portion 16 formed on the cap rubber 14 as the tire gets older. When the tire gets further older, separations may be generated between the belt layer 15 and the base rubber of the tread. However, the tire rubber member 8 manufactured according to the above-mentioned method constitutes the base rubber that has the low oil-containing layer 12 and the high oil-containing layer 13. Therefore, belt-separation resistance on the inner periphery side of the base rubber near the belt layer 15 can be increased, and groove cracking resistance on the outer peripheral side of the base rubber near the groove portion 16 can be increased.

The oil-containing ratio in the first rubber portion 1 is preferably 5 to 10% by weight in order to effectively increase the belt-separation resistance of the low oil-containing layer 12 composed of the first rubber portion 1. Also, the oil-containing ratio in the second rubber portion 2 is preferably 12 to 22% by weight in order to effectively increase the groove cracking resistance of the high oil-containing layer 13 composed of the second rubber portion 2. Degree of hardness (HS) of the first rubber portion 1 measured by a durometer JIS-K 6253 (type-A) is, for example, 57. Degree of hardness (HS) of the second rubber portion 2 is, for example, 72.

As the rubber ribbon 3 used for forming the tire rubber member 8 constituting the base rubber of the tread including the low oil-containing layer 12 and the high oil-containing layer 13, for example, the width of the rubber ribbon is more than 10 mm and less than 30 mm, and the thickness of the rubber ribbon is more than 0.5 mm and less than 3.0 mm. As for the ratio of the thickness of the first rubber portion 1 with respect to the thickness of the rubber ribbon 3 is, for example, more than 0.3 and less than 0.7. The ratio of the width of the second rubber portion 2 with respect to the width of the first rubber portion 1 in the rubber ribbon 3 is, for example, more than 0.67 and less than 1.5. The overlapping width when the rubber ribbon 3 is wound spirally along a circumferential direction of a tire is, for example, more than 10% and less than 80% with respect to the width of the rubber ribbon 3.

### Another Embodiment

As the sectional shape of a rubber ribbon, in addition to the trapezoidal shape illustrated in FIG. 1, a rectangular shape (A) and a flat hexagonal shape (B) are exemplified as shown in FIG. 5. As the rubber ribbon, it is possible to employ not only the rubber ribbon constituted of the first rubber portion 1 and the second rubber portion 2 overlapped with each other in a thickness direction thereof with the boundary face therebetween extending in a width direction as illustrated in FIGS. 1 and 2, but also a rubber ribbon 33 illustrated in FIG. 6 constituted of a first rubber portion 1 and a second rubber portion 2 with a boundary face extending in a thickness direction.

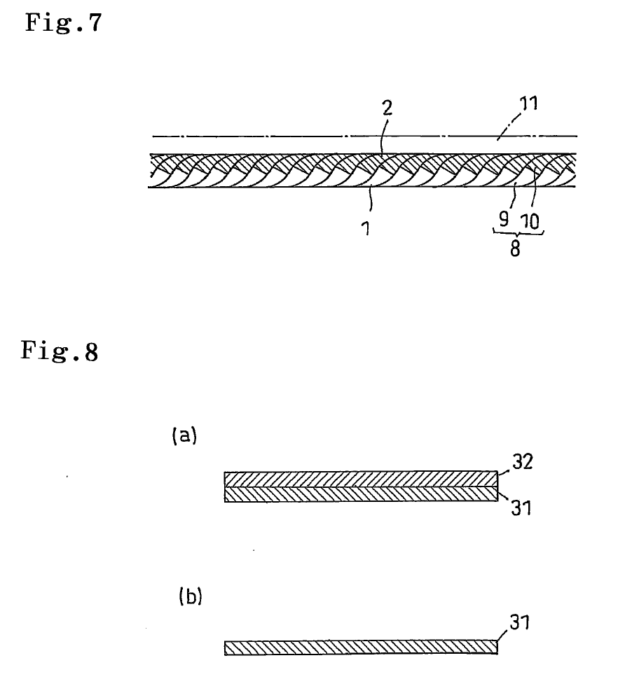

When the tire rubber member is formed by using the rubber ribbon 33 so as to have the inner liner layer and the intermediate layer, it is possible to form a tire rubber member 8 including an inner liner layer 9 and an intermediate layer 10 interposed between the inner liner layer 9 and the carcass layer 11 as illustrated in FIG. 7. In this case, the inner liner layer 9 can be formed efficiently and reliably with the first rubber portion 1 constituted of a low air permeable rubber.

### EXAMPLES

Examples, which particularly demonstrate constitutions and effects of the present invention, will be described below. Evaluation items in the examples were measured as follows.

### (1) Productivity of Tire Rubber Member

Time required for forming a tire was measured and evaluated using an index with reference to Comparative Example 1 defined as 100. The larger value indicates the shorter forming time, i.e., superior in productivity.

### (2) Anti-Air Permeability

Measurement was carried out in accordance with ASTM D1434, and air permeability coefficient was calculated and evaluated using an index with reference to Comparative Example 1 defined as 100. The smaller value indicates the superiority in anti-air permeability.

### Example 1

The tire rubber member 8 having the inner liner layer 9 and the intermediate layer 10 illustrated in FIG. 3 was formed in accordance with the method for manufacturing a tire rubber member of the present invention. As the rubber ribbon, there is used the rubber ribbon 3 composed of the first rubber portion 1 and the second rubber portion 2 joined to each other with the boundary face therebetween extending along a longitudinal direction thereof. The first rubber portion 1 is composed of a rubber composition conventionally used as an inner liner layer, while the second rubber portion 2 is composed of a rubber composition conventionally used as an intermediate layer. In the employed rubber ribbon 3, the rubber ribbon width was 28 mm, the rubber ribbon thickness was 1.4 mm, the ratio of the thickness of the first rubber portion 1 with respect to the thickness of the rubber ribbon 3 was 0.4, the ratio of the width of the second rubber portion 2 with respect to the width of the first rubber portion 1 in the rubber ribbon 3 was 0.6, and the overlapping width of the rubber ribbon 3 spirally wound along a circumferential direction of a tire was 6.0 mm.

### Comparative Example 1

After forming the inner liner layer by spirally winding a rubber ribbon of only a first rubber portion constituted in the same rubber composition as that used in Example 1 along a circumferential direction of a tire, the intermediate layer was formed on the inner liner layer by winding a rubber ribbon of only the second rubber portion constituted of the same rubber composition as that used in Example 1. The tire rubber member including the inner liner layer and the intermediate layer was thus formed. Table 1 shows the evaluation results.

TABLE 1

| | | | Comparative |
|---|---|---|---|
| | | Example 1 | Example 1 |
| Evaluation | Productivity | 150 | 100 |
| | of tire | | |
| | rubber member | | |
| | Anti-air | 100 | 100 |
| | permeability | | |

As demonstrated in Table 1, compared to Comparative Example 1 in which a rubber ribbon composed of only a first rubber portion and a rubber ribbon composed of only a second rubber portion are respectively wound, in Example 1, it is demonstrated that the productivity of Example 1 was increased since the intermediate layer and the inner liner layer are formed at a time to be built up on one another. In addition, Example 1 ensures the anti-air permeability at the same level as that of Comparative Example 1.

### (3) Groove Cracking Resistance

In accordance with ASTM D4482, the samples were subjected to a heat aging at 70° C. for five days. Measurement was carried out using a Monsant Endurance Tester under the conditions of test temperature 23° C., stretching ratio 100%, speed of 100 cycles/minute, and evaluation was made using an index defining the repeated number up to the fatigue destruction of Comparative Example 4 as 100. The larger value indicates the superiority in groove cracking resistance.

### (4) Belt-Separation Resistance

After the sample tire was subjected to heat aging at 70° C. for 56 days, a durability performance test was carried out in accordance with JIS D4230. The final test step was extended. After running 20,000 km, tire was disassembled. The separation amount was evaluated with an index defining the amount of Comparative Example 4 as 100. The larger value indicates the superiority in belt-separation resistance.

### Example 2

The tire rubber member 8 illustrated in FIG. 4, which constitutes the base rubber of the tread including the low oil-containing layer 12 as the first rubber layer 1L and the high oil-containing layer 13 as the second rubber layer 2L, was formed in accordance with the method for manufacturing a tire rubber member of the present invention. As the rubber ribbon, the rubber ribbon 3 including the first rubber portion 1 and the second rubber portion 2 composed of the respective rubber compositions indicated in the upper column in Table 2, which are joined to each other with the boundary face therebetween extending along a longitudinal direction thereof. The rubber ribbon width of the employed rubber ribbon 3 was 20 mm, the rubber ribbon thickness was 1.5 mm, the ratio of the thickness of the first rubber portion 1 with respect to the thickness of the rubber ribbon 3 was 0.5, the ratio of the width of the second rubber portion 2 with respect to the width of the first rubber portion 1 in the rubber ribbon 3 was 0.7, and the overlapping width of the rubber ribbon 3 spirally wound along a circumferential direction of a tire was 3.0 mm.

### Comparative Example 2

The tire rubber member constituting the base rubber of the tread was formed by spirally winding, along a circumferential direction of a tire, a rubber ribbon of only the first rubber portion 1 composed of the same rubber composition as that used in Example 2. The shape of the tire rubber member such as the thickness of the base rubber was set to be identical to that of Example 2.

### Comparative Example 3

The tire rubber member constituting the base rubber of the tread was formed by spirally winding, along a circumferential direction of a tire, a rubber ribbon of only the second rubber portion 2 composed of the same rubber composition as that used in Example 2. The shape of the tire rubber member such as the thickness of the base rubber was set to be identical to that of Example 2.

### Comparative Example 4

The tire rubber member constituting the base rubber of the tread including the low oil-containing layer and the high oil-containing layer was formed as described below. The low oil-containing layer is formed by spirally winding, along a circumferential direction of a tire, a rubber ribbon of only the first rubber portion composed of the same rubber composition as that used in Example 1, and subsequently, the high oil-containing layer was formed by winding, on the low oil-containing layer, a rubber ribbon of only the second rubber portion composed of the same rubber composition as that used in Example 2. The evaluation results are given in the lower column of Table 2. The productivity of the tire rubber member was evaluated with an index defining that of Comparative Example as 100.

TABLE 2

| | | | | | Compar- | Compar- | Compar- |
|---|---|---|---|---|---|---|---|
| | | | | | ative | ative | ative |
| | | | | Example 2 | Example 2 | Example 3 | Example 4 |
| Composition | First | Solution | NS 116 manufactured by ZEON Co., Ltd. | 55 | 55 | — | 55 |
| | rubber | polymerization SBR | | | | | |
| | portion | Carbon black | N339 manufactured by TOKAI CARBON Co., Ltd. | 30 | 30 | — | 30 |
| | | Oil (Aromatic oil) | manufactured by JAPAN ENERGY CORPORATION | 7 | 7 | — | 7 |
| | | Antioxidant | Antigen 6C manufactured by SUMITOMO CHEMICAL | 1 | 1 | — | 1 |
| | | | CO., LTD. | | | | |
| | | Curing accelerator 1 | Soxinol D-G manufactured by SUMITOMO | 1 | 1 | — | 1 |
| | | | CHEMICAL CO., LTD. | | | | |
| | | Curing accelerator 2 | NOCCELER CZ manufactured by Ouchi Shinko | 1.2 | 1.2 | — | 1.2 |
| | | | Chemical Co., Ltd. | | | | |
| | | Sulfur powder | manufactured by TURUMI Chemical Co., Ltd. | 1.8 | 1.8 | — | 1.8 |
| | | Stearic acid | manufactured by NOF CORPORATION | 1 | 1 | — | 1 |
| | | Zinc oxide | Zinc oxide No. 3 manufactured by MITSUI MINING | 2 | 2 | — | 2 |
| | | | CO., LTD. | | | | |
| | Second | Solution | NS 116 manufactured by ZEON Co., Ltd. | 45 | — | 45 | 45 |
| | rubber | polymerization SBR | | | | | |
| | portion | Carbon black | N339 manufactured by TOKAI CARBON Co., Ltd. | 30 | — | 30 | 30 |
| | | Oil (Aromatic oil) | manufactured by JAPAN ENERGY CORPORATION | 17 | — | 17 | 17 |
| | | Antioxidant | Antigen 6C manufactured by SUMITOMO CHEMICAL | 1 | — | 1 | 1 |
| | | | CO., LTD. | | | | |
| | | Curing accelerator 1 | Soxinol D-G manufactured by SUMITOMO | 1 | — | 1 | 1 |
| | | | CHEMICAL CO., LTD. | | | | |
| | | Curing accelerator 2 | NOCCELER CZ manufactured by Ouchi Shinko | 1.2 | — | 1.2 | 1.2 |
| | | | Chemical Co., Ltd. | | | | |
| | | Sulfur powder | manufactured by TURUMI Chemical Co., Ltd. | 1.8 | — | 1.8 | 1.8 |
| | | Stearic acid | manufactured by NOF CORPORATION | 1 | — | 1 | 1 |
| | | Zinc oxide | Zinc oxide No. 3 manufactured by MITSUI MINING | 2 | — | 2 | 2 |
| | | | CO., LTD. | | | | |

| | | | | | |
|---|---|---|---|---|---|
| Evaluation | Productivity of tire rubber member | 150 | 150 | 150 | 100 |
| | Groove cracking resistance | 100 | 70 | 120 | 100 |
| | Belt-separation resistance | 100 | 120 | 70 | 100 |

In Example 2, the low oil-containing layer and the high oil-containing layer can be formed at a time to be built up on one another. Therefore, it is demonstrated in Table 2 that, compared to Comparative Example 4 in which the rubber ribbon composed of only the first rubber portion and the rubber ribbon composed of only the second rubber portion were wound separately, the productivity of Example 2 is increased. Also, in Example 2, the low oil-containing layer and the high oil-containing layer were made thinner. Therefore, the base rubber including the low oil-containing layer and the high oil-containing layer can be formed with the same thickness as that in Comparative Examples 2 and 3. It is demonstrated that, compared to Comparative Examples 2 and 3, the tire rubber member, in which the groove cracking resistance and the belt-separation resistance are increased in well balance, was formed.

What is claimed is:

1. A method for manufacturing a tire rubber member, the method comprising: spirally winding a rubber ribbon including a first rubber portion and a second rubber portion, each composed of a rubber having different physical characteristics and joined to each other with a boundary face extending therebetween along a longitudinal direction thereof, along a circumferential direction of a tire so that the second rubber portion is disposed on an outer peripheral side of the first rubber portion, to form the tire rubber member in which a second rubber layer formed with the second rubber portion is built up on the outer periphery of the tire of a first rubber layer formed with the first rubber portion.

2. The method for manufacturing a tire rubber member according to claim 1, wherein the first rubber portion is composed of a low air permeable rubber, and the tire rubber member is formed to include an inner liner layer as the first rubber layer and an intermediate layer as the second rubber layer, said intermediate layer is interposed between the inner liner layer and a carcass layer.

3. The method for manufacturing a tire rubber member according to claim 1, wherein the second rubber portion is composed of a rubber of which an oil-containing ratio is higher than that of the first rubber portion, and the tire rubber member is formed to constitute a base rubber of a tread including a low oil-containing layer as the first rubber layer and a high oil-containing layer as the second rubber layer.
